(19) United States
(12) Patent Application Publication
(10) Pub. No.: US 2026/0152021 A1
(43) Pub. Date: Jun. 4, 2026

(54) Device, Systems and Methods for Binding Documents and Articles

(71) Applicant: Christopher Michael Considine, Lenox, MA (US)

(72) Inventor: Christopher Michael Considine, Lenox, MA (US)

(21) Appl. No.: 19/177,406

(22) Filed: Apr. 11, 2025

Related U.S. Application Data
(60) Provisional application No. 63/633,324, filed on Apr. 12, 2024.

(51) Int. Cl. B42F 1/02

(52) U.S. Cl. CPC B42F 1/02

(57) ABSTRACT

Binder clip partitioning devices, systems and methods are disclosed. In an example, a binder clip partitioning device may be configured such that it is sectioned off by middle walls to allow multiple documents to be intermingled without paperclips. In an example, a binder clip is configured to bind sheets of paper together using an embedded partitioning system. The binder clip may include a clip body having a spine, a first handle coupled to the clip body, a second handle coupled to the clip body, and a clamp. The spine of the clip body can be configured with the embedded partitioning system encapsulated inside the clip body, wherein the embedded partitioning system includes a partitioning device coupled to the spine of the clip body. The partitioning device can be configured with a plurality of interior walls along one or more edges of the spine of the clip body.

### RELATED APPLICATION(S)

This application claims the benefit of U.S. Provisional Application No. 63/633,324, filed on Apr. 12, 2024. The entire teachings of the above application are incorporated herein by reference.

### BACKGROUND

Existing commercial technologies, such as staples, paperclips, and binder clips, are designed to bind paper sheets or materials together. The plastic binder clip, a common office staple, emerged from a need for a more efficient way to bind documents than the traditional method of sewing or punching holes and tying with string. For example, papers and other articles may be bound together using a binder clip. Conventional binder clips for sheets of paper are often made of metal and/or plastic.

### SUMMARY

While technologies exist that can be useful to hold papers intact, issues remain. Documents encapsulated within a binder clip are typically not separated from each other. Binder clips can impede organization of the documents held within the clip. Binder clips can make unintended impressions in the papers, causing permanent damage to the papers. Binder clips can further cause issues with papers if they tear or crease the paper, or if they leave rust stains. For archival storage, binder clips can be harmful to archival storage and conservation.

Binder clips are typically made of plastic and spring steel. If thrown away while encapsulating paper, binder clips can impede the efficiency and scalability of the recycling process of the paper encased within, as the plastic and spring steel components are not recyclable.

Example binder clip partitioning devices, systems and methods in the present disclosure can overcome shortcomings associated with existing binder clips by embedding a partitioning array at the spine of the clip. In an embodiment, example binder clip partitioning devices, systems and methods in the present disclosure can provide enhanced organization.

Binder clip devices, systems and methods are disclosed. An example binder clip is configured to bind sheets of paper together using an embedded partitioning system. The binder clip may include a clip body having a spine, a first handle coupled to the clip body, a second handle coupled to the clip body, and a clamp. The clamp can be configured with a first handle and a second handle, the first handle and the second handle being interconnected with the clip body. The spine of the clip body can be configured with the embedded partitioning system encapsulated inside the clip body, wherein the embedded partitioning system includes a partitioning device coupled to the spine of the clip body. The partitioning device can be configured with a plurality of interior walls along one or more edges of the spine of the clip body.

In an embodiment, example binder clip partitioning device, systems and methods may be comprised of sustainably sourced materials. In an embodiment, the disclosed binder clip may be composed of pluripotent plastic.

In an example preferred embodiment, example binder clip partitioning devices, systems and methods may a binder clip may be provided that allow documents to be stored together and separated into partitions without the use of paper clips and staples.

In an embodiment, the partitioning system may be configured with micro spacing through expansion gaps. By integrating micro spacing between the partitioning system, the paper sets can be encapsulated in the partitions in a robust and secure fashion. Micro movements to the paper partitions can be made without the paper buckling, wrinkling, or cupping. The expansion gaps enable the binder clip to expand and contract in response to movement of the clip body or in response to temperature and moisture change. Proper spacing through the expansion gaps avoids damage to the paper and enhances the structural integrity of the of the paper partitions and helps protect the surface area of the encapsulated papers by give the partitioned paper sets more leeway.

Binder clip devices, systems and methods disclosed herein can provide for dividing documents (paper) into partitions and maintain the structural integrity of the partitioned papers. In some example embodiments, the disclosed binder clip devices, systems and methods can enable enhanced separation and protection of partitioned papers by integrating expansion gaps in the spine of the binder clip.

The expansion gaps can enable robust expansion and contraction of the binder clip. For instance, the expansion gaps can enable movement including of the handles of the clip 104 and the clip body, while mitigating buckling or cupping of the encapsulated paper in each of the partitions.

Further, the expansion gaps can protect encapsulated paper sets encapsulated in each the partitions from being inadvertently released by the user, ensuring the paper partitions are intact, while enable intentional manipulation of the papers therein by the user.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a bottom perspective view of a binder clip partitioning device according to a two-wall embodiment.

FIG. 2 is a front view with the bottom facing up according to a two-wall embodiment of FIG. 1.

FIG. 3 is a front view according to a two-wall embodiment of FIG. 1.

FIG. 4 is a bottom view according to a two-wall embodiment of FIG. 1.

FIG. 5 is a top view according to a two-wall embodiment of FIG. 1.

FIG. 6 is a left-side view according to a two-wall embodiment of FIG. 1.

FIG. 7 is a right-side view according to a two-wall embodiment of FIG. 1.

FIG. 8 is a bottom perspective view of a binder clip partitioning device according to a three-wall embodiment.

FIG. 9 is a front view with the bottom facing up according to the binder clip partitioning device three-wall embodiment of FIG. 8.

FIG. 10 is a front view according to the binder clip partitioning device three-wall embodiment of FIG. 8.

FIG. 11 is a bottom view according to the binder clip partitioning device three-wall embodiment of FIG. 8.

FIG. 12 is a top view according to the binder clip partitioning device three-wall embodiment of FIG. 8.

FIG. 13 is a left-side view according to the binder clip partitioning device three-wall embodiment of FIG. 8.

FIG. 14 is a right-side view according to the binder clip partitioning device three-wall embodiment of FIG. 8.

FIG. 15 is a bottom perspective view of a binder clip partitioning device according to an embedded built-in three wall embodiment with expansion gaps in between partitions.

FIG. 16 is a side view with the bottom facing up according to the binder clip partitioning device with an embedded built-in three wall embodiment of FIG. 15.

FIG. 17 is a side top view according to the binder clip partitioning device embedded built-in three wall embodiment of FIG. 15.

FIG. 18 is a bottom view according to the binder clip partitioning device embedded built-in three wall embodiment of FIG. 15.

FIG. 19 is a top view according to the binder clip partitioning device embedded built-in three wall embodiment of FIG. 15.

FIG. 20 is a left-side view according to the binder clip partitioning device embedded built-in three wall embodiment of FIG. 15.

FIG. 21 is right-side view according to the binder clip partitioning device embedded built-in three wall embodiment of FIG. 15.

FIG. 22 is a side view with the bottom facing up of a binder clip partitioning device according to an embedded built-in four wall embodiment with expansion spacing in between partitions according to an embodiment of FIG. 22.

FIG. 23 is a front side view with the bottom facing up according to the binder clip partitioning device embedded built-in four wall embodiment with expansion spacing in between partitions according to an embodiment of FIG. 22.

FIG. 24 is a front side view according to the binder clip partitioning device embedded built-in four wall embodiment with expansion spacing in between partitions according to an embodiment of FIG. 22.

FIG. 25 is a bottom view according to the binder clip partitioning device embedded built-in four wall embodiment with expansion spacing in between partitions according to an embodiment of FIG. 22.

FIG. 26 is a top view according to the binder clip partitioning device embedded built-in four wall embodiment with expansion spacing in between partitions according to an embodiment of FIG. 22.

FIG. 27 is a left-side view according to the binder clip partitioning device embedded built-in four wall embodiment with expansion spacing in between partitions according to an embodiment of FIG. 22.

FIG. 28 is a right-side view according to the binder clip partitioning device embedded built-in four wall embodiment with expansion spacing in between partitions according to an embodiment of FIG. 22.

### DETAILED DESCRIPTION

A description of example embodiments follows.

Binder clip devices, systems and methods are disclosed. Example binder clip devices disclosed herein provide for dividing documents (paper) into partitions and maintain the structural integrity of the partition. Further, example embodiments of the disclosed binder clip devices, systems and methods enable for enhanced protection of partitioned papers by integrating expansion gaps in the design.

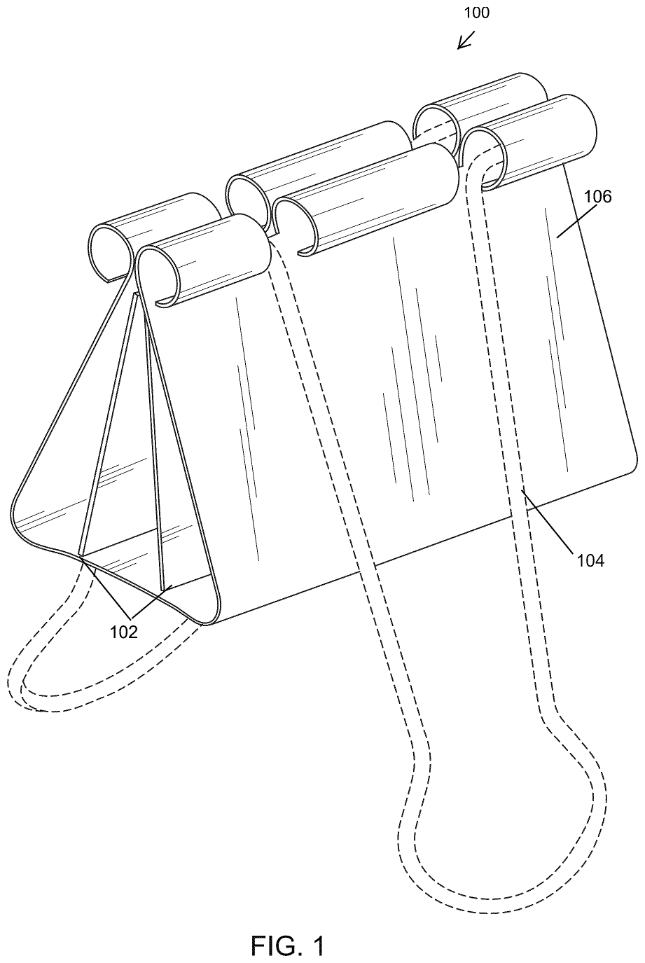

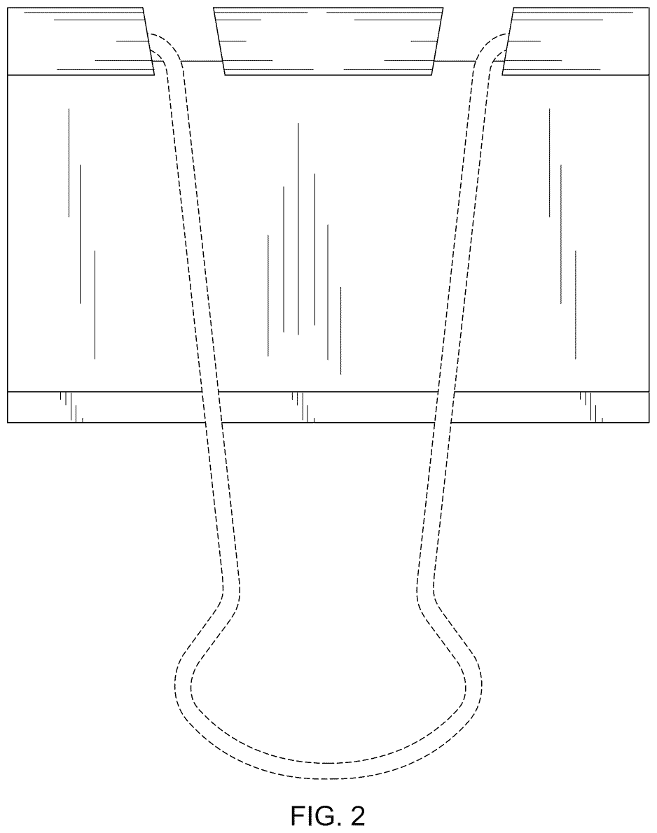

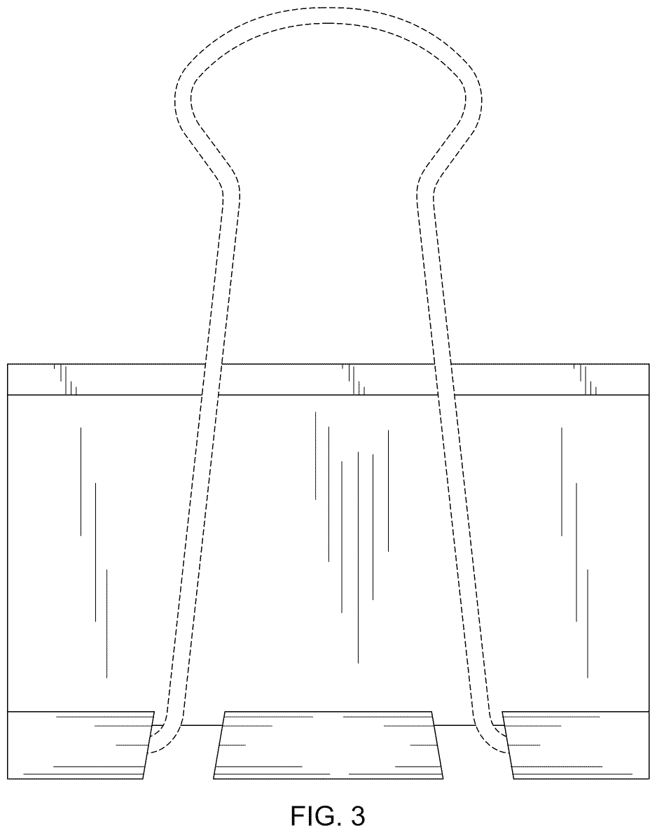

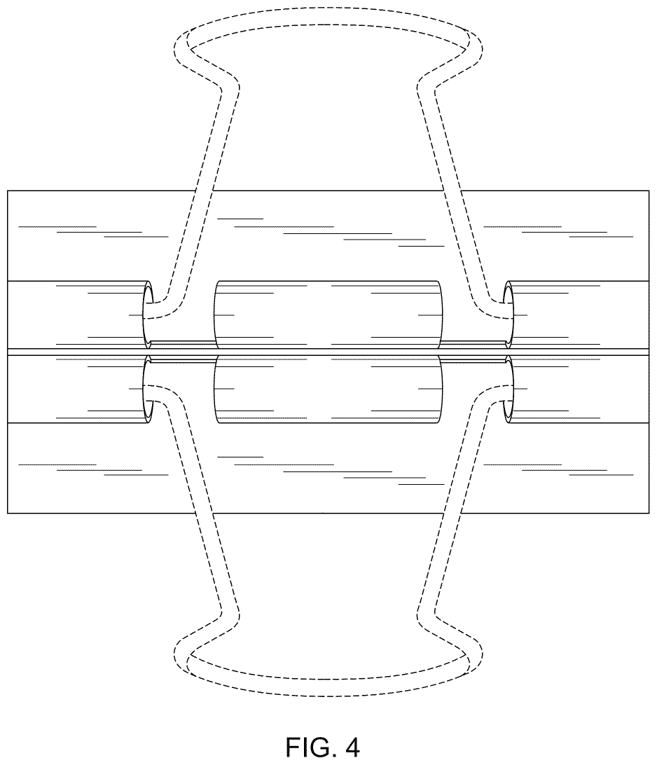

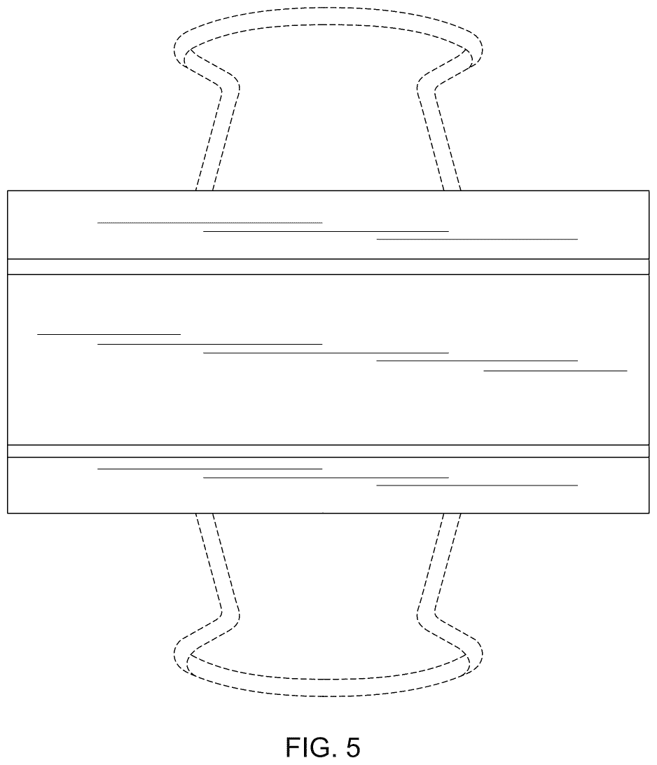

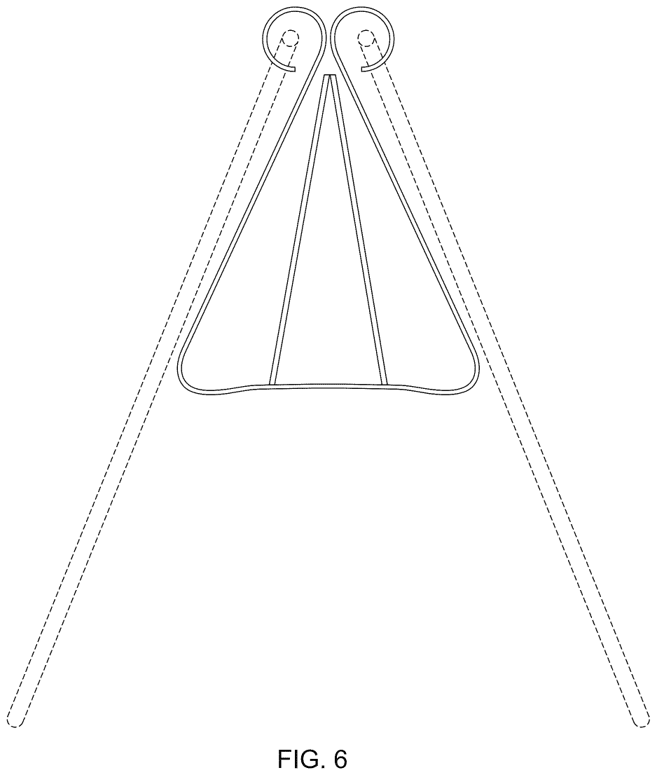

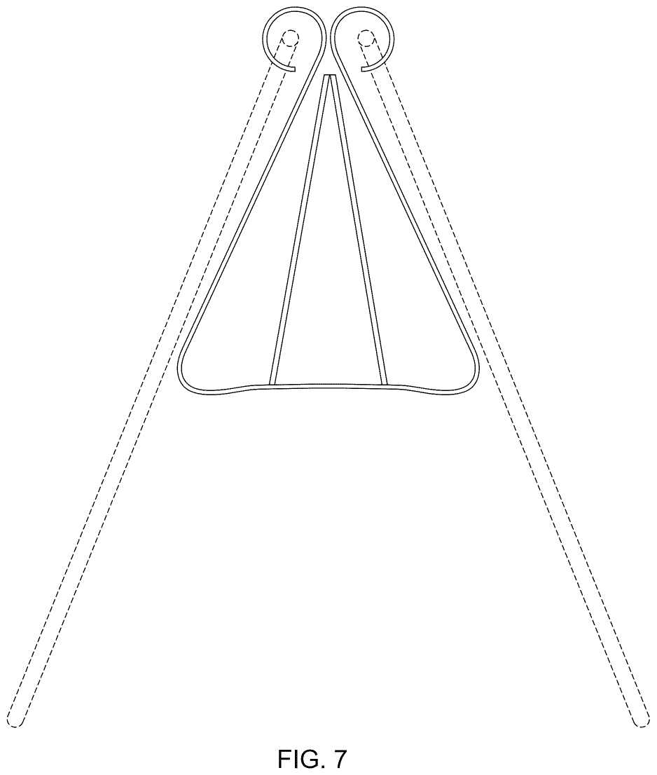

FIGS. 1-7 show various views of a binder clip partitioning device according to a two-wall embodiment. FIG. 2 is a side front view of FIG. 1, FIG. 3 is a side top view of FIG. 1, FIG. 4 is a bottom view, FIG. 5 is a top view, FIG. 6 is a left-side view, and FIG. 7 is a right-side view of the binder clip partitioning device according to the two-wall embodiment of FIG. 1.

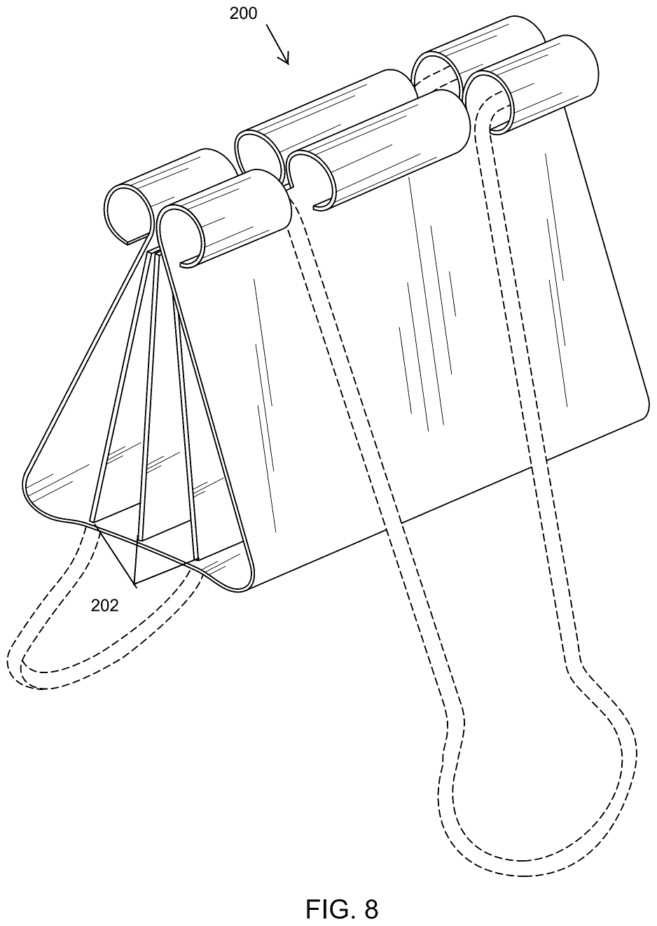

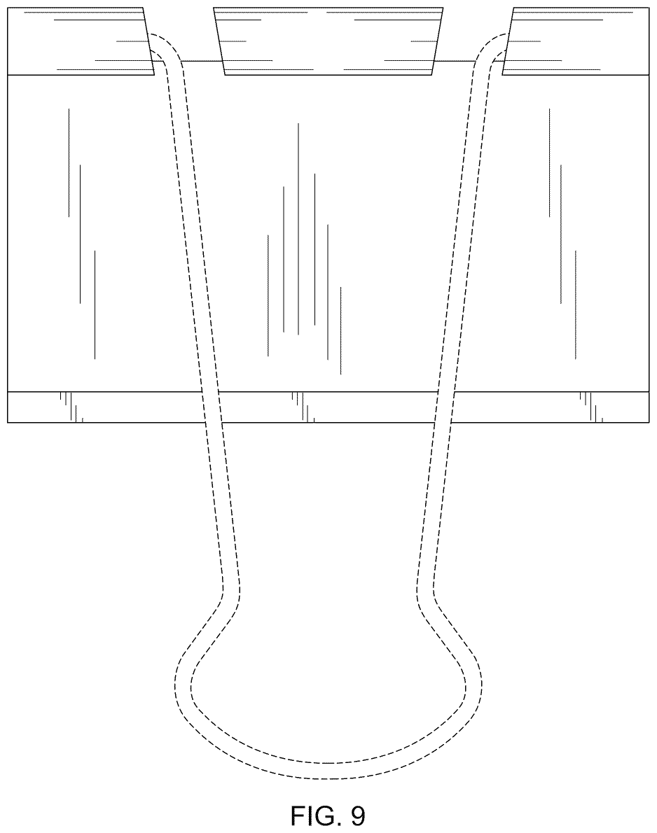

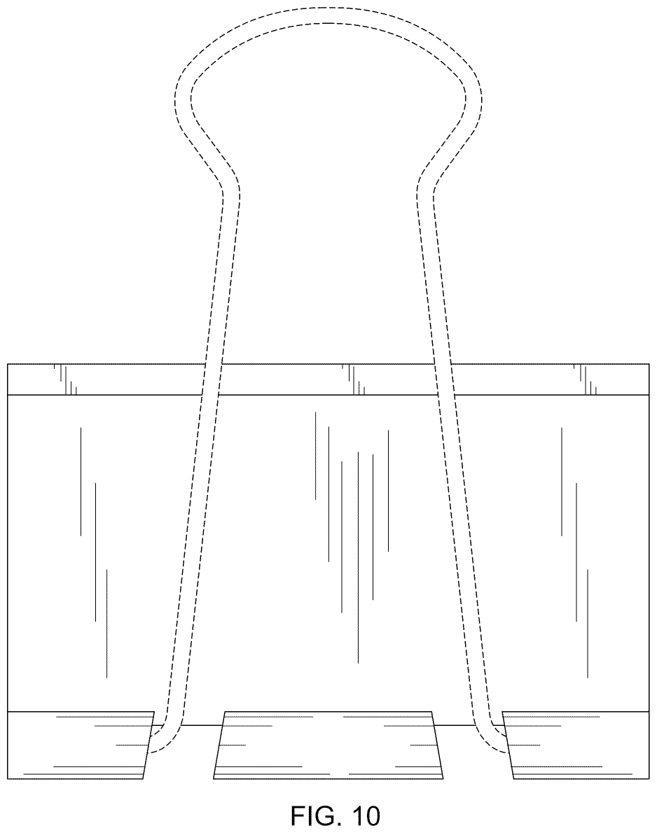

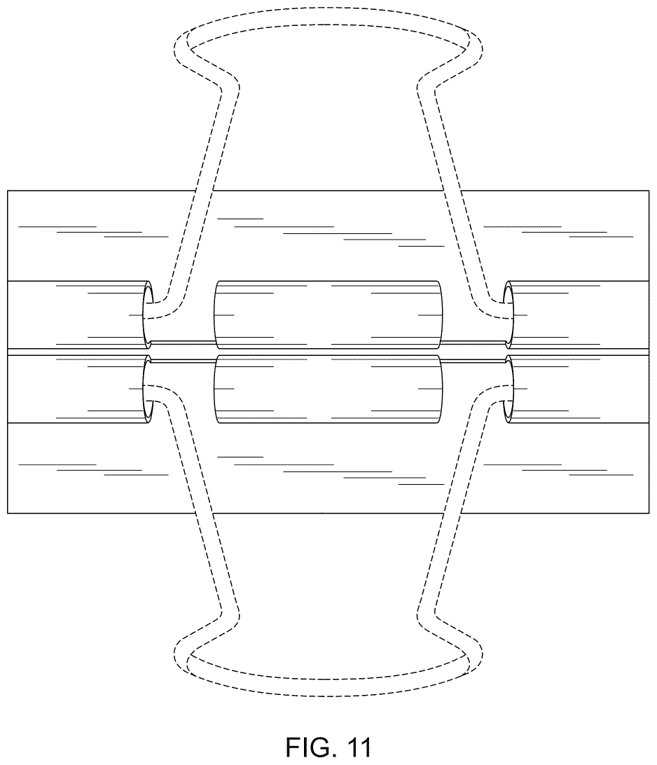

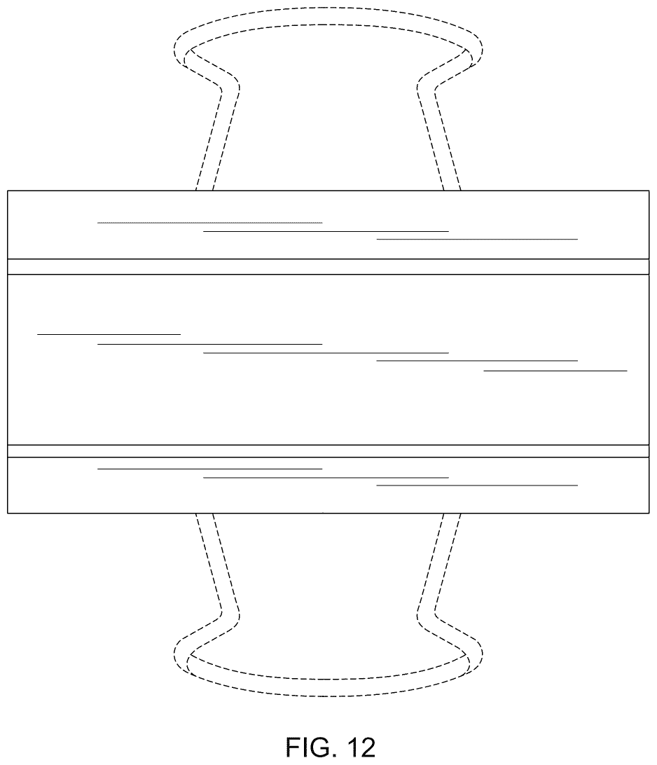

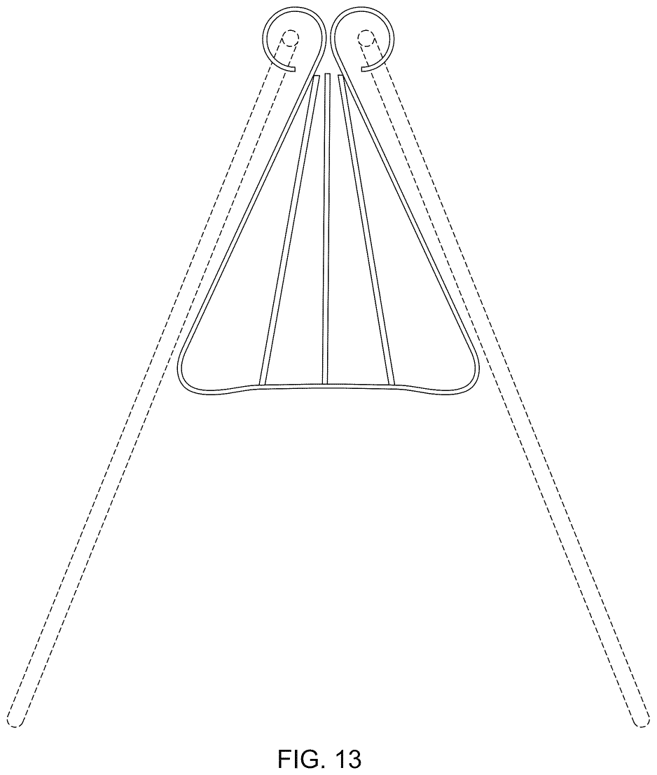

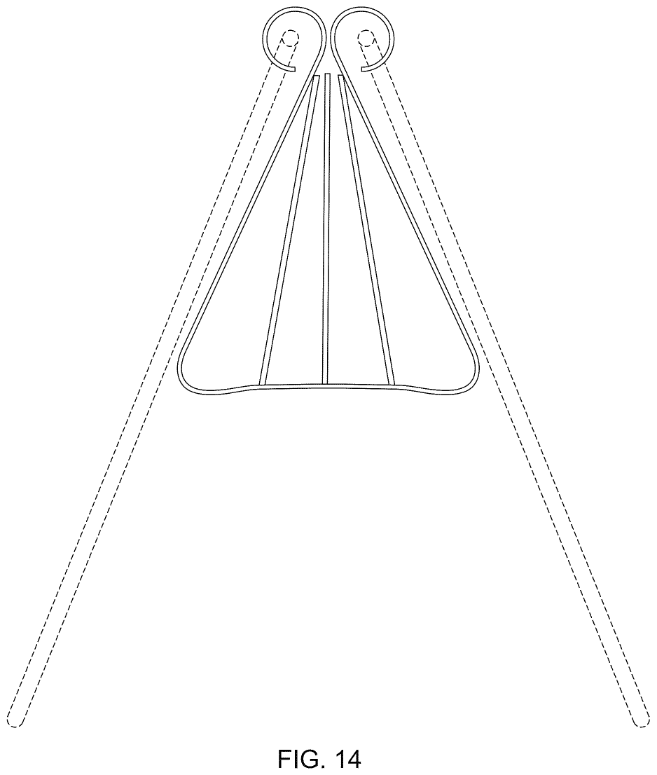

FIGS. 8-14 show various views of a binder clip partitioning device according to a three-wall embodiment. FIG. 9 is a side view, FIG. 10 is a side top view of FIG. 8, FIG. 11 is a bottom view of FIG. 8, FIG. 12 is a top view of FIG. 8, FIG. 13 is a left-side view of FIG. 8, and FIG. 14 is a right-side view of the binder clip partitioning device according to a three-wall embodiment of FIG. 8.

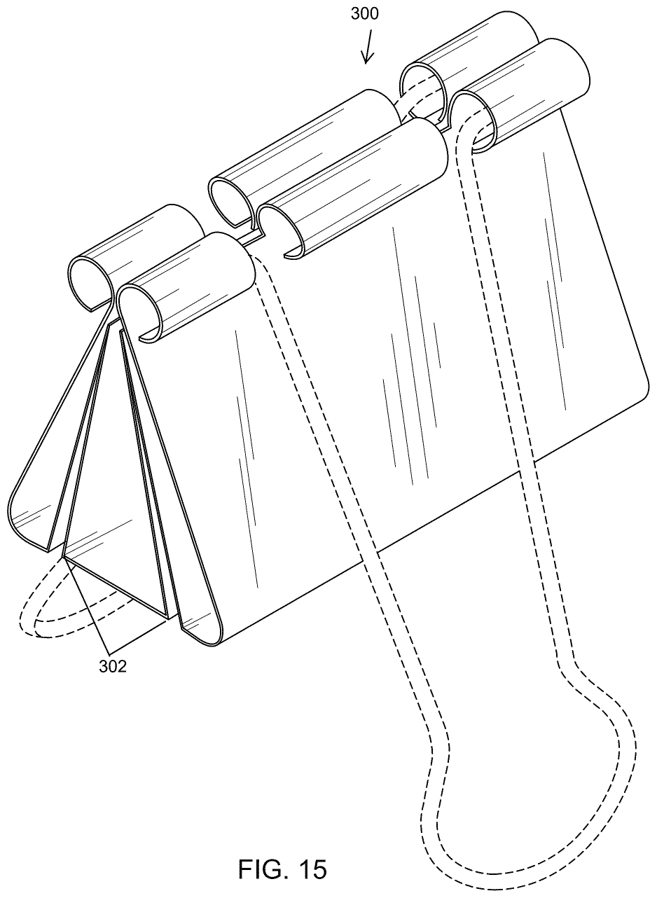

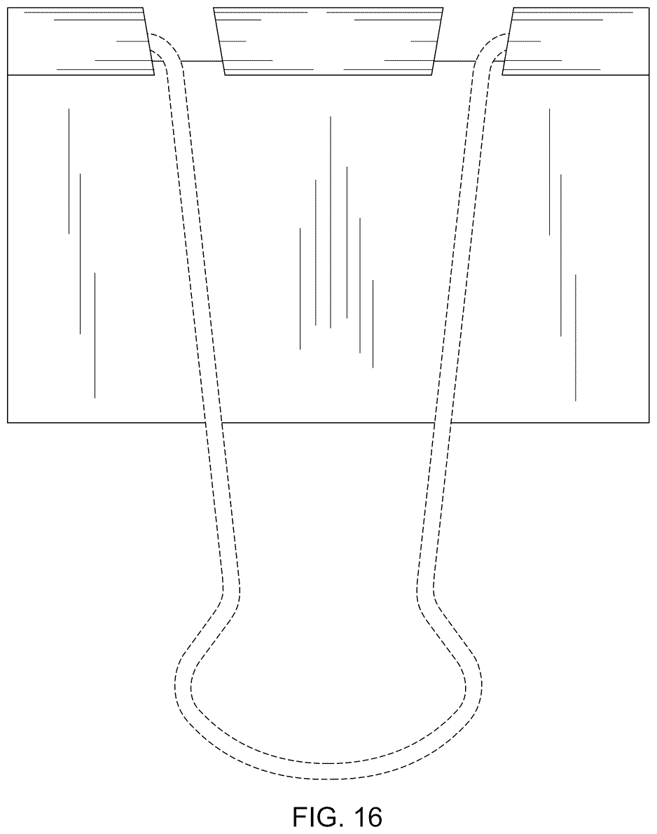

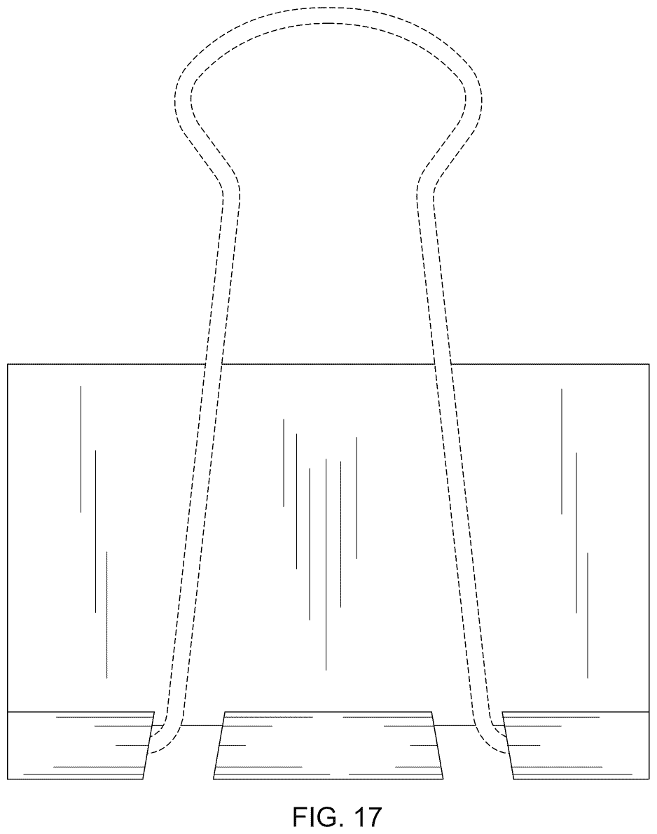

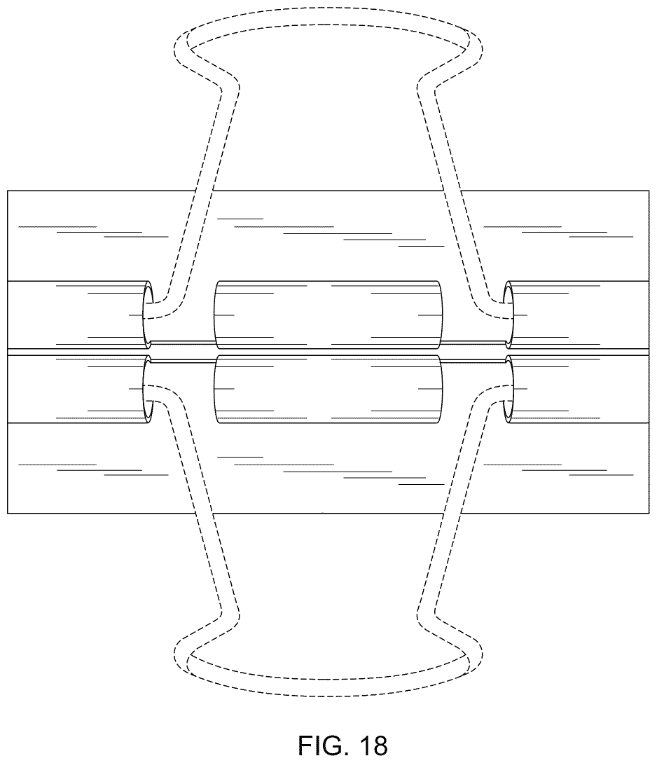

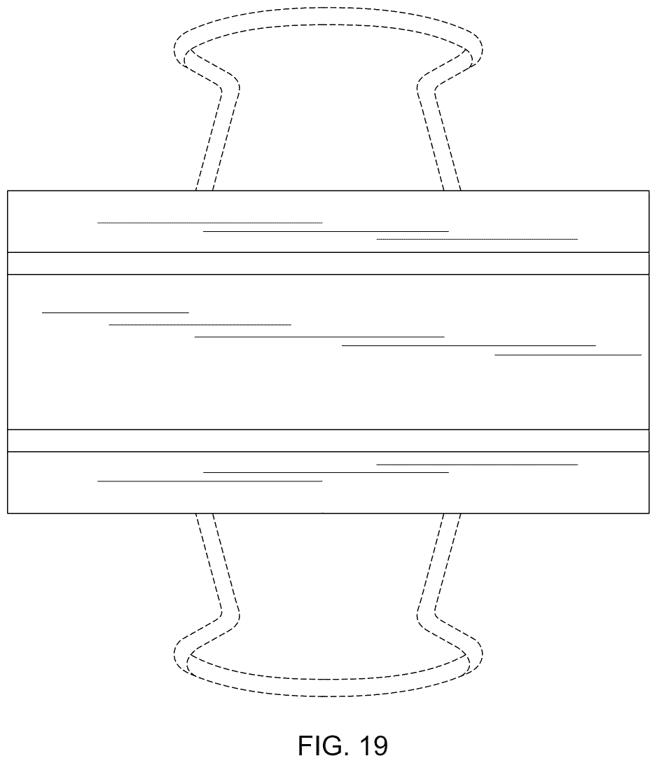

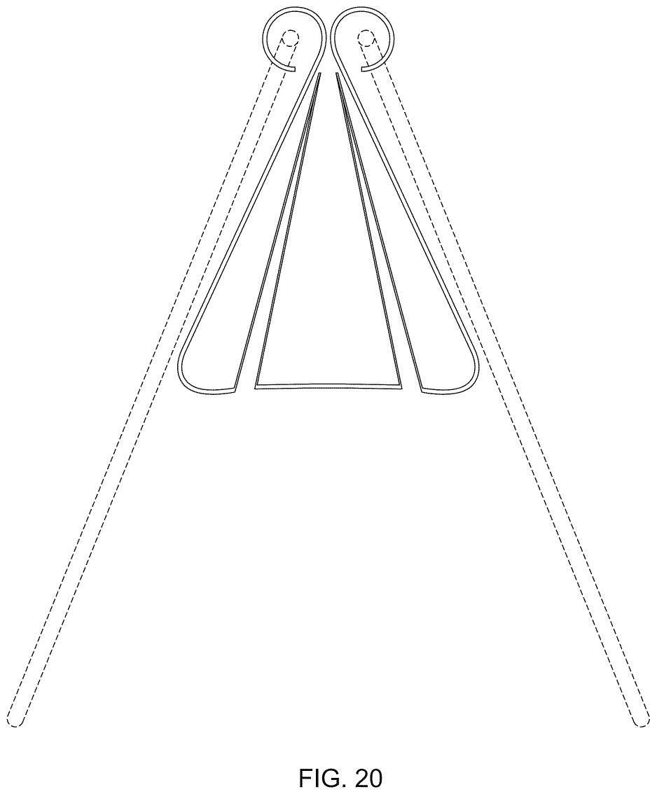

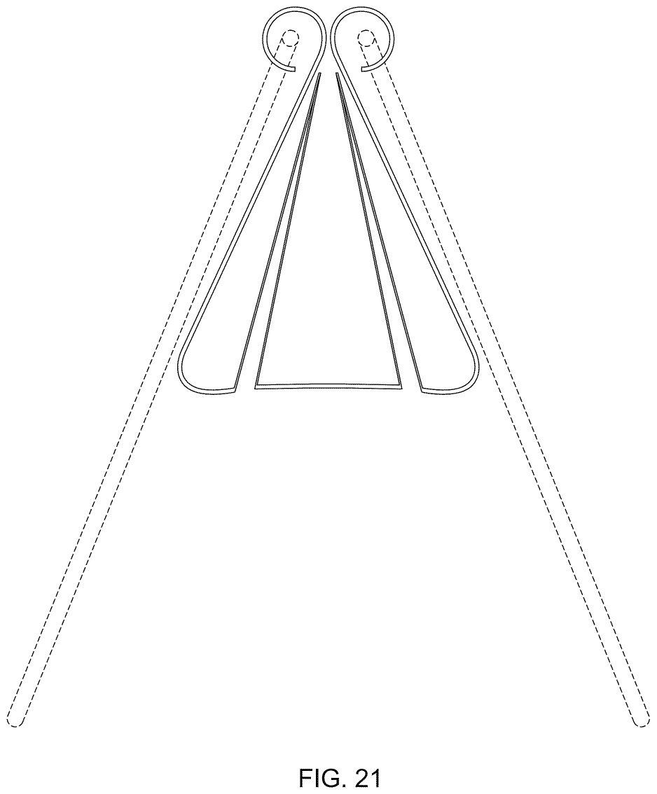

FIGS. 15-21 show various views of a binder clip partitioning device according to an embedded built-in three wall embodiment with expansion gaps in between partitions. FIG. 16 is a side bottom view, FIG. 17 is a side to view, FIG. 18 is a top view, FIG. 19 is a bottom view, FIG. 20 is a left-side view, FIG. 21 is a right-side view according to an embedded built-in three wall embodiment with expansion gaps in between partitions.

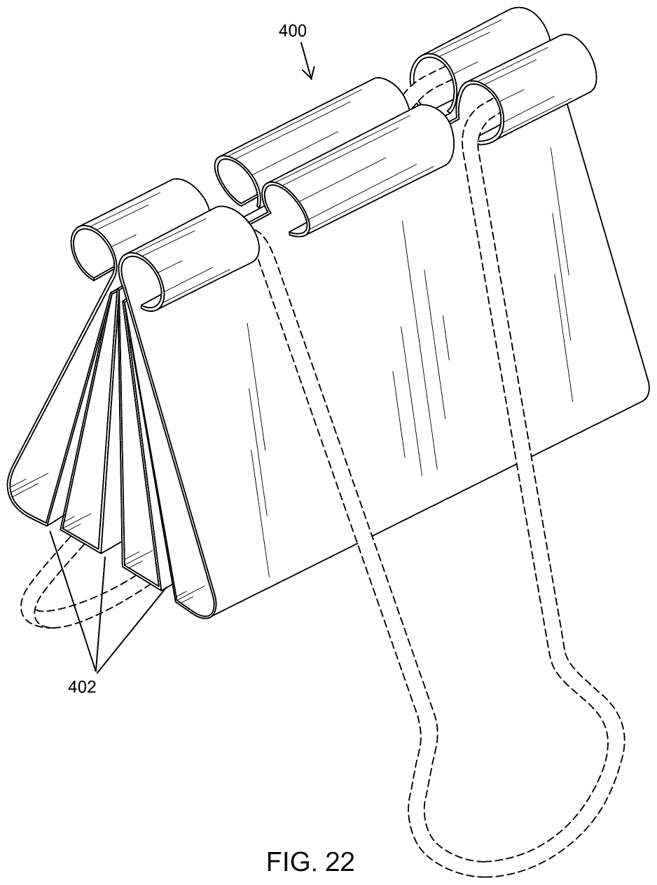

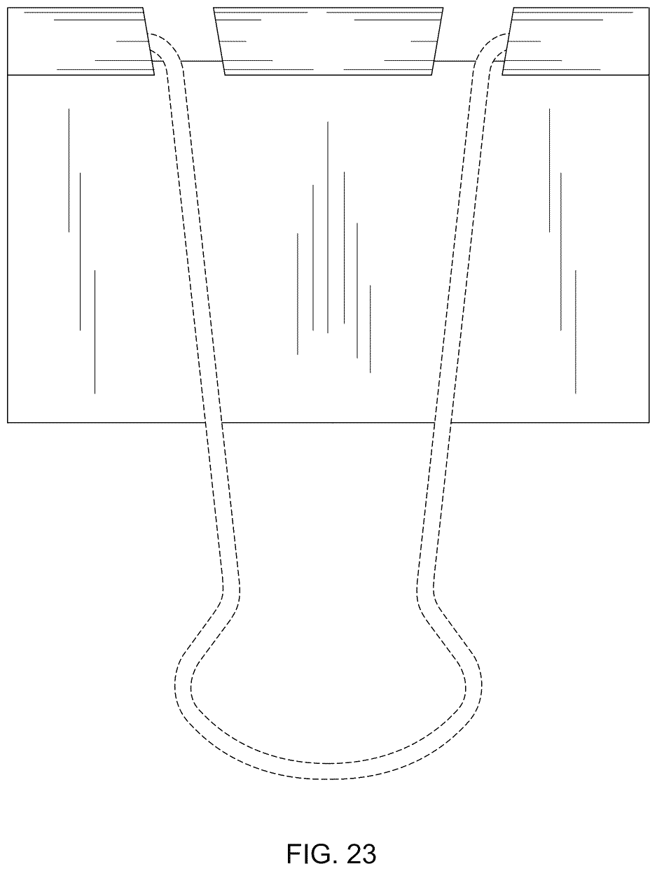

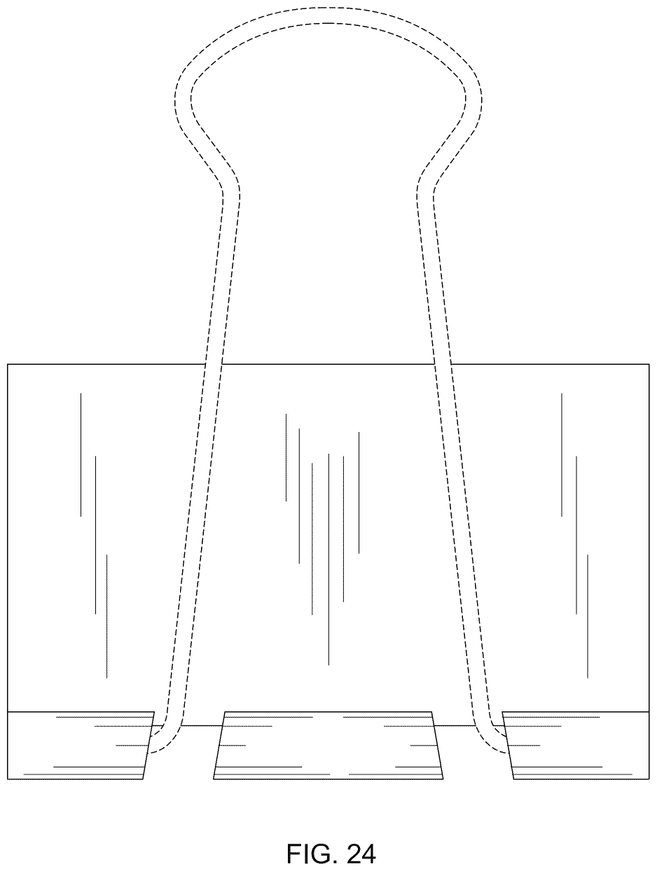

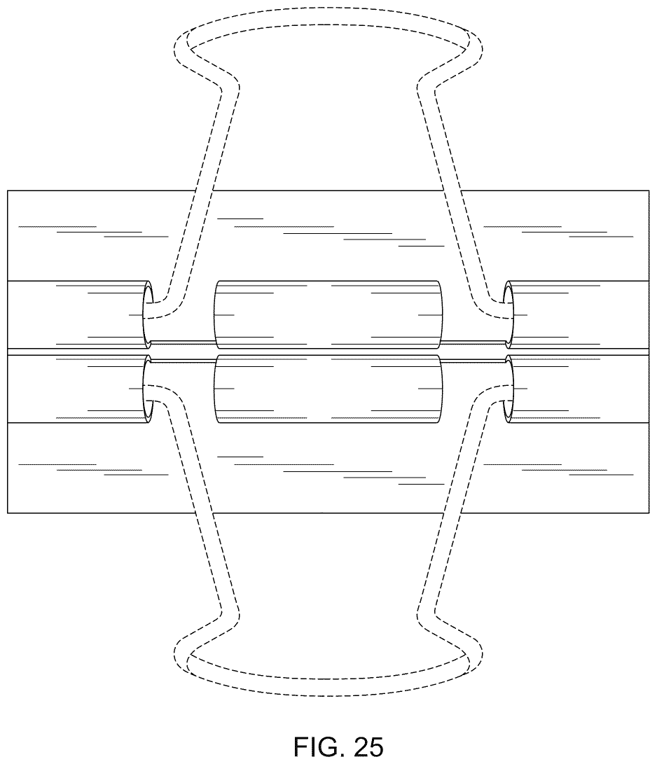

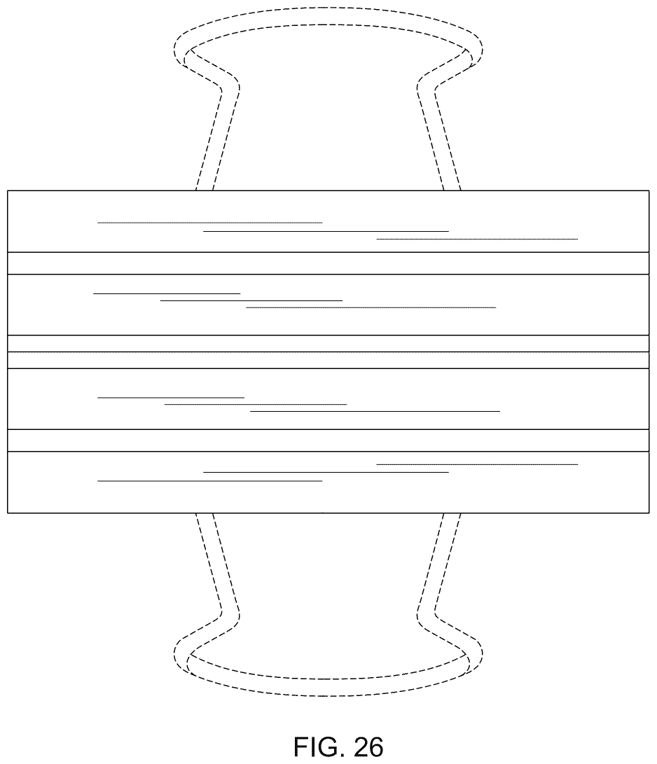

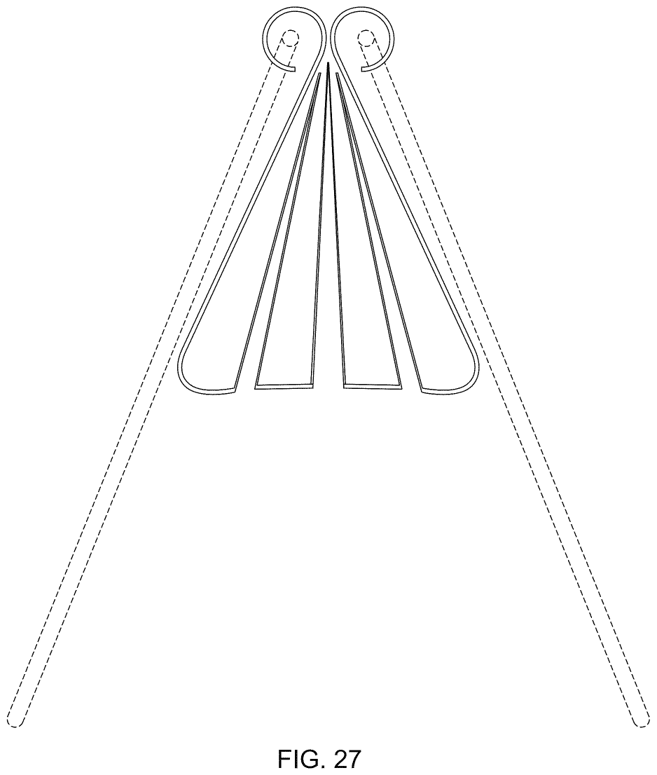

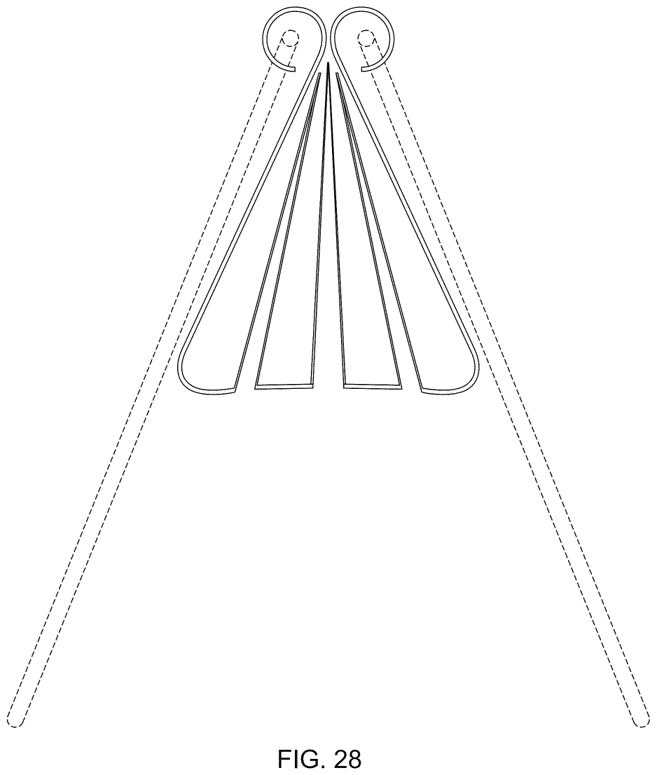

FIGS. 22-28 show various views of a binder clip partitioning device according to according to an embedded built-in four wall embodiment with expansion gaps in between partitions. FIG. 23 is a side bottom view, FIG. 24 is a side top view, FIG. 25 is a top view, FIG. 26 is a bottom view, FIG. 27 is a left-side view, and FIG. 28 is a right-side view of a binder clip partitioning device according to an embedded built-in three wall embodiment.

Referring to FIGS. 1-28, example binder clips 100, 200, 300, 400 can be configured to bind sheets of paper together using embedded partitioning systems 102, 202. The binder clip 106, 2306, 306, 406 may include a clip body having a spine, a first handle 104, 204, 304, 404 coupled to the clip body, a second handle coupled to the clip body, and a clamp. The clamp can be configured with a first handle and a second handle, the first handle and the second handle being interconnected with the clip body. The spine of the clip body can be configured with the embedded partitioning system encapsulated inside the clip body, wherein the embedded partitioning system 102, 104 includes a partitioning device coupled to the spine of the clip body. The partitioning device can be configured with a plurality of interior walls along one or more edges of the spine of the clip body. Referring to FIGS. 15-28, as shown specifically in FIGS. 15 and 22, the partitioning system may be configured with micro spacing through expansion gaps 302, 402.

By integrating micro spacing between the partitions in expansion gaps 302, 402, the paper sets that are encapsulated in the partitions can have micro movements without buckling, wrinkling, or cupping the papers. The expansion gaps enable the binder clip 300, 400 to expand and contract in response to movement of the clip body or in response to temperature and moisture change. Proper spacing through the expansion gaps avoids damage to the paper and enhances the structural integrity of the of the paper partitions and helps protect the surface area of the encapsulated papers by give the partitioned paper sets more leeway.

The expansion gaps 302, 402 can enable robust expansion and contraction of the binder clip 300, 400. For instance, the expansion gaps 302, 402 can enable movement including of the handles of the clip 104 and the clip body 106, while mitigating buckling or cupping of the encapsulated paper in each of the partitions.

Further, the expansion gaps 302, 402 can protect encapsulated paper sets that are encapsulated in each the partitions from being inadvertently released by the user, ensuring the paper partitions are intact, while enable intentional manipulation of the papers therein by the user.

The disclosed binder clips 100, 200, 300, 400 can help enable documents to be stored together into partitions without the use of paper clips and staples. The partitioned systems and the expansion gaps of the disclosed binder clips 100, 200, 300, 400 provide sectioned walls allows for different documents to be stored effectively in only a single binder clip. In this way, the disclosed binder clip can make paperclips and staples obsolete while performing the similar tasks with only one object (the binder clip). While the disclosed binder clips herein show examples of up to four walled sections, it is envisioned that the partitioned walled chambers encapsulating papers could be more than four.

Referring to FIGS. 1-7, an item or collection of papers may be squeezed and slotted into an opening of the clip 100 when the handles 104 are pinched together, and documents can be held in the partitioning system 102 once the handles are released, and the documents become clipped, secured inside the binder clip 104.

In one embodiment, the disclosed binder clips could be made using a 3d printing system from a 3d model or creating the plastic component of the clip in a factory setting. The clips in another embodiment could be implemented in a factory setting using primary metal.

By encapsulating papers into partitions in the disclosed binder clip, documents can be easily managed and secured without use of staples or paper clips. Such documents can be sectioned off without the need for other components being used. They would do this by pinching the metal clips, while attached to the plastic component, to open the closed end of the clip. After placing necessary documents inside clip, between walled sections, stop pinching the metal pieces and then fold metal pieces over the documents.

Example primary materials of example embodiments of the binder clips may include: Metals, Rubbers, Woods, and/or Polymers. Example metal materials may include: Spring steel, Aluminum Alloys, Stainless steel, Copper, Bronze, Titanium, Silver, Gold, Tool Steel, and/or Platinum. Example rubber materials may include: Natural Rubber, and/or Synthetic Rubber. Example wood materials may include: Wood, Hardwoods, Softwoods and/or Engineered Woods. Example polymer materials may include: Acrylic or Polymethyl Methacrylate (PMMA), Polycarbonate (PC), Polyethylene (PE), Polypropylene (PP), Polyethylene Terephthalate (PETE or PET), Polyvinyl Chloride (PVC), and/or Acrylonitrile-Butadiene-Styrene (ABS).

### Example Biodegradable Embodiments

With the growth of the stationary industry, come large amounts of stationary waste and chemicals. One way of combating the problems with stationery waste begins with recycling. Conventional approaches of recycling and/or stationary waster, however, can suffer from significant drawbacks. Conventional recycling and regenerating approaches can be expensive, resource intensive, and may involve complex and involve harsh hydrolyzing agents, pollution, waste-water discharge, excessive carbon emissions, and create substantial carbon release.

Further, papers held together by paper clips, staples, and other non-biodegradable objects can impede the recycling process of papers. Moreover, if discarded in the ocean or in waters, such plastic and metal objects holding papers do not easily dissolve in the ocean, and can be disruptive to oceanic life.

Example durable and sustainable binder composition systems and methods in the present disclosure can overcome the shortcomings of conventional binder clips, for example, by providing non-toxic, biodegradable, low-energy, and naturally sourced compositions with substantially enhanced durability. The durable and sustainable products of the present disclosure can provide substantial resilience. The disclosed example durable and sustainable composition systems and methods can overcome the shortcomings of conventional stationary technologies, for example, by providing non-toxic, biodegradable, low-energy, and natural composition structures with substantially enhanced durability. The durable and sustainable stationary products of the present disclosure can provide substantial resilience relative to existing stationary products that can be renewable, reusable and recyclable.

Example durable and sustainable binder clip composition systems and methods in the present disclosure can overcome the shortcomings of conventional stationary technologies, for example, by manufacturing a binder clip composition composed of non-toxic, biodegradable, low-energy, and natural materials with substantially enhanced durability. The durable and sustainable binder clip products of the present disclosure can provide substantial resilience relative to existing clips.

In an example embodiment, an inner thermoplastic polymer material may be used for the clip body. In an example embodiment, the inner layer of thermoplastic polymer material joins the handles, which could be manufactured using a biodegradable composition, such as supramolecular plastics, which dissolve in the ocean or algae-based plastics.

In another example embodiment, the binder clip can be comprised of Aeschynomene aspera root transformations. In an embodiment, the plurality of three-dimensional root derived binder clip manipulations are arranged on the outer layer in arrays.

According to the embodiment, the Aeschynomene aspera root is a sustainable and biodegradable natural root. The Aeschynomene aspera root transformations are manipulated into weather resistant configurations capable of withstanding exposure to high levels of UV light, saltwater spray, extreme cold and dramatic temperature changes while substantially maintaining shape, tensile strength and durability. In an example, a plurality of layers of bark on the Aeschynomene aspera root are stripped and extracted, and an internal, cork-like center of the Aeschynomene aspera root is planned into thin strips to make the handle and/or the clip body. The Aeschynomene aspera be formed into three-dimensional binder clip manipulations. Each of the respective three-dimensional binder clip manipulations may be treated with at least one coating of acrylic to ensure that its respective manipulated shape and structure is maintained and undisturbed ed by friction or contact with external elements.

In an embodiment, the Aeschynomene aspera root transformation is encapsulated and sealed using nontoxic sealer to maintain substantial tensile strength and abrasion resistance, while impeding mold and mildew growth. In an embodiment, the acrylic may be an acrylic-based copolymer or eco-poly sealer.

In an example embodiment, an Aeschynomene aspera root binder clip transformations may be configured into individual three-dimensional manipulated formations. The individual three-dimensional manipulated formations may be preferably encapsulated, respectively, with one or more acrylic layers to increase durability and resistance to the natural elements. The resulting individual encapsulated manipulated formations are designed to withstand friction from external forces and elements, and maintain durability and shape while withstanding substantial wear and tear when exposure to the natural elements for substantial periods of time.

The resulting Aeschynomene aspera root binder clip composition system can provide significant strength, and provides a higher load capacity, and can be durable in extreme weather, such that its endurance can withstand the impact of hail. The Aeschynomene aspera root manipulations can be molded into any physical shape, effect, or pattern of the binder clip composition. According to an embodiment, the Aeschynomene aspera root is a sustainable and biodegradable natural root. The Aeschynomene aspera root transformations are manipulated into weather resistant configurations capable of withstanding exposure to high levels of UV light, saltwater spray, extreme cold and dramatic temperature changes while substantially maintaining shape, tensile strength and durability.

In an example, a plurality of layers of bark on the Aeschynomene aspera root are stripped and extracted, and an internal, cork-like center of the Aeschynomene aspera root is planned into thin sheets. The Aeschynomene aspera thin sheets are soaked and formed into three-dimensional binder clip manipulations.

In one embodiment, the example binder clip manipulations may be treated with at least one coating of acrylic to ensure that its respective manipulated shape and structure is maintained and undisturbed ed by friction or contact with the natural elements.

In one embodiment, each of the respective three-dimensional binder clip manipulations may be treated with at least one coating with film-forming polymer dissolved in a volatile organic solvent. The polymer may be nitrocellulose, or cellulose acetates such as Cellulose acetate butyrate (CAB, Tenite II) Testing data evidence that the manipulated transformations can maintain shape, while withstanding inclement weather exposure for at least three months.

The resulting Aeschynomene aspera root binder clip composition system can provide significant strength, and provides a higher load capacity, and can be durable in extreme weather, such that its endurance can withstand the impact of hail.

In an example, a plurality of layers of bark on the Aeschynomene aspera root are stripped and extracted, and an internal, cork-like center of root fibers of the Aeschynomene aspera root is planned into thin sheets. The Aeschynomene aspera thin sheets are soaked and then formed and molded into three-dimensional binder clip manipulations. The three-dimensional binder clip manipulations may be treated with at least one coating of acrylic to ensure that they can withstand the elements and hold shape.

In an embodiment, the binder clip composition assembly heat bond of the inner layer may and mesh substrate can be joined by a heat-curable structural adhesive. For example, a non-rubber-modified epoxy resin, a reaction product of a carboxyl- or amine-terminated butadiene polymer or copolymer and a bisphenol F-based epoxy resin, or an elastomeric toughener containing capped isocyanate groups may be used. The structural adhesive can develop improved bonding properties when cured at moderate temperatures from 120 to 170° C., and enjoy improved longevity

While example embodiments have been particularly shown and described, it will be understood by those skilled in the art that various changes in form and details may be made therein without departing from the scope of the embodiments encompassed by the appended claims.

What is claimed is:

1. A device comprising:
a binder clip device configured to bind sheets of paper together using an embedded partitioning system, the binder clip device comprising:
a clip body having a spine;
a first handle coupled to the clip body;
a second handle coupled to the clip body;
a clamp having a first handle and a second handle, the first handle and the second handle being interconnected with the clip body; and
the spine of the clip body being configured with the embedded partitioning system encapsulated inside the clip body, wherein the embedded partitioning system includes a partitioning device coupled to the spine of the clip body, the partitioning device being configured with a plurality of interior walls along one or more edges of the spine of the clip body.

2. The binder clip device as in claim 1 wherein the plurality of interior walls further includes:
a first interior wall coupled to a first portion of the spine configured to encapsulate a first binding of sheets of paper; and
a second interior wall coupled to a second portion of the spine configured to encapsulate a second binding of sheets of paper.

3. The device as in claim 2 wherein the plurality of interior walls in the partitioning device further includes a third interior wall coupled to a third portion of the spine configured to encapsulate a third binding of sheets of paper.

4. The device as in claim 3 wherein the plurality of interior walls in the partitioning device further includes a fourth interior wall coupled to a further portion of the spine configured to encapsulate a fourth binding of sheets of paper.

5. The device as in claim 1 wherein the plurality of interior walls is at least two or more interior walls.

6. The device as in claim 1 wherein the first interior wall and second interior wall are configured with respective expansion gaps.

7. The device as in claim 6 wherein the respective expansion gaps create a gap between in the spine in between the first interior wall and the second interior wall.

8. The device as in claim 1 wherein the binder clip device is comprised of compostable materials.

9. The device as in claim 8 wherein the binder clip device is comprised of substantially supramolecular polymers configured to fully dissolve in seawater.

10. The device as in claim 8 wherein the compostable materials are derived in substantial part from Aeschynomene aspera root.

11. The device as in claim 1 wherein the plurality of interior walls in the partitioning device are configured to cause a separation among a first set of documents and a second set of documents.

12. A method of providing a binder clip comprising:
configuring a binder clip device to bind sheets of paper together using an embedded partitioning system by:
configuring a clip body having a spine;
configuring a first handle coupled to the clip body;
configuring a second handle coupled to the clip body;
configuring a clamp having a first handle and a second handle, the first handle and the second handle being interconnected with the clip body; and
configuring the spine of the clip body to encase the embedded partitioning system encapsulated inside the clip body, wherein the embedded partitioning system includes a partitioning device coupled to the spine of the clip body, the partitioning device being configured with a plurality of interior walls along one or more edges of the spine of the clip body.

13. A system of providing a binder clip comprising:
means for providing a binder clip device to bind sheets of paper together using an embedded partitioning system by:
means for configuring a clip body having a spine;
means for configuring a first handle coupled to the clip body;
means for configuring a second handle coupled to the clip body;
means for configuring a clamp having a first handle and a second handle, the first handle and the second handle being interconnected with the clip body; and
means for configuring the spine of the clip body to encase the embedded partitioning system encapsulated inside the clip body, wherein the embedded partitioning system includes a partitioning device coupled to the spine of the clip body, the partitioning device being configured with a plurality of interior walls along one or more edges of the spine of the clip body.
